(19) United States
(12) Patent Application Publication
(10) Pub. No.: US 2011/0207593 A1
(43) Pub. Date: Aug. 25, 2011

(54) Expansivity in Low Expansion Silica-Titania Glasses

(76) Inventors: Carlos Duran, Ottawa (CA); Kenneth Edward Hrdina, Horseheads, NY (US); John Edward Maxon, Canton, NY (US)

(21) Appl. No.: 13/028,516

(22) Filed: Feb. 16, 2011

Related U.S. Application Data
(60) Provisional application No. 61/308,073, filed on Feb. 25, 2010.

(51) Int. Cl. C03C 3/06; C03C 3/076; C03B 19/06; C03B 25/00

(52) U.S. Cl. 501/54; 501/55; 65/17.4

(57) ABSTRACT

This disclosure is directed to tailoring and improving the expansivity of low thermal expansion silica-titania glass through changes in the [OH] content and fictive temperature of the glasses. The [OH] concentration in the glass can be in the range of 600-2500 ppm. The fictive temperature, T_{F} is less than 900° C.

### PRIORITY

This application claims the priority of the U.S. Provisional Patent Application No. 61/308,073 titled “Improved Expansivity in Low Expansion Silica-Titania Glasses” that was filed Feb. 25, 2010 in the name of inventors Kenneth E, Hrdina and John E. Maxon.

### FIELD

This disclosure is directed to tailoring and improving the expansivity of low thermal expansion silica-titania glass through changes in the [OH] content and fictive temperature of the glasses.

### BACKGROUND

Silica-titania glasses have been known for several decades. U.S Pat. No. 3,690,855, “Method for producing TiO₂—SiO₂ Glasses,” teaches that a glass consisting of 1-20 wt % TiO₂has a coefficient of thermal expansion (CTE) of essentially zero over a temperature range of −200° C. to 700° C. with heat treatment. However, there is considerable difficulty in polishing this material due to the presence of a titania crystalline phase in the glass. As a result, the glass cannot be readily used in some application such as those for image masks. European Patent No. 1 608 598 teaches a silica-titania containing glass with a fictive temperature (T_{F}) of 1200° C. or lower, the glass having with [OH] levels (concentration) “at most” 600 pm or less. However, this glass obtains low T_{F} values only at lower [OH] levels; and does not identify high OH as a means of getting lower T_{F} values with improved expansivity properties. U.S. Patent Application Publication No. US2006/0179879 A1 teaches a method of making a silica-titania glass which has an [OH] level in the range of 100 ppm to 1500 ppm.

Silica-titania such as ULE® glass (Corning Incorporated) has been identified by the by the EUV (extreme ultraviolet) industry as a material highly useful for extreme ultraviolet lithographic (EUVL) applications due to its polishability and zero-CTE crossover range at 20° C. of 0±5 ppb/° C. In the area of EUV lithography, in 2007, the International Technology Roadmap for Semiconductors found that there is a likelihood of increasing the number of mirrors needed in the imaging lens in order to improve resolution. As a result, it will be necessary to use higher energy power sources in order to compensate for losses (primarily due to scatter and heating of elements) during the lithographic process. With the use of higher energy power sources there will be a higher thermal gradient in the lenses that could lead to problems unless there is a CTE improvement in the present silica-titania materials being used. For example, photomask temperatures could reach temperatures as high as 80° C. Additionally, there is the expectation that future specifications will have more stringent overall requirements that the current silica-titania materials may not be to meet.

As a result of the present and forthcoming changes for silica-titania glasses for use in EUV lithography, improvements are required. The present disclosure is directed to new silica-titania glasses that have an improved expansivity over current glasses. As will be shown herein, the teaching of the present disclosure are counter to prior art teaching that one needs to reduce the [OH] content to obtain a lower T_{F} and hence improve expansivity.

### SUMMARY

The present disclosure is directed to silica-titania glasses (also known as titania doped silica glasses) with low fictive temperatures (T_{F}) and an increased [OH] content, the [OH] content being in the range of 600 ppm to 2500 ppm. In one embodiment the [OH] content is in the range of 800-2000 ppm. The silica-titania glass according to the disclosure has a titania content in the range of 5 wt % to 14 wt %. In one embodiment the titania content is in the range of 6.5 wt % to 9 wt %. The silica-titania glass disclosed with an improved expansivity can be used, for example without limitation, in semiconductor optics, masks and stages, nano-imprint technology, and for mirrors for optics in space applications. In another embodiment the disclosure is directed to a method of making silica-titania glasses with low fictive temperatures (T_{F}) and an increased [OH] content, the [OH] content being in the range of 600 ppm to 2500 ppm, using selected controlled an 2500 ppm enables the formation of silica titania glasses with lower fictive temperatures and improved thermal expansion behavior for a given annealing rate or cycle than glasses having lower [OH], for example, [OH] of 600 ppm or less. In one embodiment the [OH] is greater than 600 ppm and T_{F} is less than 950° C. In another embodiment the [OH] is greater than 600 ppm and T_{F} is less than 900° C. In an additional embodiment the silica-titania glass has a fictive temperature T_{F} of less than 950° C. and an OH content of ≧800 ppm. On a further embodiment the glass has a fictive temperature T_{F} of less than 900° C. and an OH content of ≧800 ppm.

In an additional embodiment the disclosure is directed to a silica-titania glass whose ΔCTE is less than 75 ppb/° K over the temperature interval between 20° C. and 100° C. In one aspect ΔCTE is less than 70 ppb/° K over the temperature interval between 20° C. and 100° C. In a further aspect ΔCTE is less than 65 ppb/° K over the temperature interval between 20° C. and 100° C.

The disclosure is also directed to a silica-titania glass whose expansivity, δCTE/dT, is less than 1.6 ppb/° K² at 20° C. In one embodiment δCTE/dT, is less than 1.5 ppb/° K². In another embodiment δCTE/dT, is less than 1.4 ppb/° K².

The disclosure is also directed to a methods for making a silica titania glass. In one embodiment the silica-titania can be made by soot-to-glass process, in which a silica-titania soot is deposited in a vessel as particulates, or on a paten or mandrel as a preform, and consolidation of the soot or preform takes place at consolidation temperatures in partial pressures of water greater than 3%. In another embodiment the partial pressure of water is greater than greater than 4%.

In another embodiment a direct process is used to make the silica-titania glass. In the direct process in accordance with this disclosure, silica-titania particles are formed by combustion of silica precursor and a titania precursor material in a burner, and the particles are consolidated into a glass in an atmosphere having a partial pressure of water greater than 3%, the consolidation being substantially simultaneous with the formation of the particles and their deposition in a vessel. In the direct process the time between silica-titania particle formation and consolidation into glass is less than 3 seconds, and typically less than 2 seconds. In one embodiment the consolidation occurs in a atmosphere having a partial pressure of water greater than 3%. In another embodiment the partial pressure of water is greater than greater than 4%.

The objective of the annealing schedule is to impart a uniform and controlled fictive temperature to the glass. The silica-titania glasses disclosed herein have an annealing point of 1040° C. or less. An example shown herein has an annealing point of approximately 1010° C. In one embodiment the annealing is carried out by heating the glass from room temperature (“RT,” approximately 18-25° C.) to a selected temperature that is at or below the annealing point of the glass since the fictive temperature will be below the annealing point of the glass. The heating can be at any rate, for example, the selected heating rate is between 25° C./Hr and 150° C./Hr. The glass is then held at the selected temperature for a time in the range 1 hour to 500 hours depending on the thickness of the glass to insure that the glass reaches a nominally uniform fictive temperature throughout the glass. In one embodiment the glass is held at the temperature for a time in the range of 75-125 hours. In one embodiment the glass is heated from RT to the point near the desired fictive temperature at a rate of less than 50° C./Hr. In another embodiment the glass is heated from RT to 600° C. at a rate in the range of 50-100° C./Hr, from 600° C. to 800° C. at a rate in the range of 25-50° C./Hr, and from 800° C. to point near the desired fictive temperature in the 840° C. to 1010° C. at a rate in the range of 10-25° C./Hr. The glass is then held at the temperature for a time in the range of 1-200 hours. The glass can then be cooled, for example at a rate of ≦10°/Hr. In another embodiment the cooling rate is ≦5° C./Hr. In another embodiment the cooling rate is ≦3° C./hr.

### BRIEF DESCRIPTION OF THE DRAWINGS

FIG. 1 is a comparison of the CTE of Cervit® (Corning Incorporated), ULE® and the glass of U.S. Pat. No. 3,390,855 (labeled 918 AS) and illustrating flatness of the curves for the different materials.

FIG. 2 is a graph of the “thermal expansion coefficient in the temperature range of 25-300° C.” versus “Total Heat Treatment Time” for a 15 wt % silica-titania glass.

FIGS. 3A and 3B together illustrate the method used to calculate fictive temperature based on a paper by Shelby, “Density of TiO₂ Doped Vitreous Silica,” Phys. Chem. of Glasses, Vol. 46 [5] (1995), pages 494-499.

FIG. 4 is a graph illustrating the fictive temperature changes as a function of the log of the annealing rate for a given TiO₂—SiO₂ glass with nominally 800 ppm OH and 7.4 wt % TiO₂.

FIGS. 5A and 5B are two charts illustrating the viscosity behavior of titania contain glasses with nominally 800 ppm OH whose CTE is nominally −15 ppb/° K and 5 ppb/° K.

FIG. 6 is graph showing a semi-empirical relationship between the partial pressure of water in the gas phase and the resultant [OH] in a TiO₂—SiO₂ glass.

FIG. 7 is a graph illustrating the impact of annealing on thermal expansion.

FIG. 8 illustrates expansivity as a function of temperature for a silica-titania glass with nominally 800 ppm [OH] and 7.4 wt % TiO₂.

FIG. 9 depicts an apparatus for making silica-titania glass by the direct method.

FIGS. 10(a) and 10(b) illustrate the steps of forming a porous silica-titania soot matrix on a bait using the VAD process and consolidating the porous preform into glass in an atmosphere having a partial pressure of water vapor of at least 3%.

FIG. 11 is a graph illustrating the fictive temperature (T_{f}) versus the annealing cooling rate for a series of glasses with different OH content and nominally the same titania content of ˜7.4 wt % TiO₂.

### DETAILED DESCRIPTION

The invention will now be described in detail with reference to a few preferred embodiments, as illustrated in the accompanying drawings. In describing the preferred embodiments, numerous specific details are set forth in order to provide a thorough understanding of the invention. However, it will be apparent to one skilled in the art that the invention may be practiced without some or all of these specific details. In other instances, well-known features and/or process steps have not been described in detail so as not to unnecessarily obscure the invention. In addition, like or identical reference numerals are used to identify common or similar elements.

Herein the terms “silica-titania glass,” titania doped silica,” and similar terms mean a glass consisting SiO₂ and TiO₂. While the glass may contain trace metals and other elements as contaminants, the total trace metals should be less than 20 ppm and preferably less than 10 ppm; and the total halogen is less than 50 ppm and preferably less than 25 ppm.

Various processes exist by which high OH titania containing glasses can be made. In one embodiment, the glass was made via the direct process in which organic precursors of silica and titania are transported to burners where combustion takes place. Exemplary organic precursors are OMCTS (octamethylcyclotetrasiloxane) for silica and TTP (titanium tetra(isopropoxide, Ti(OPri)₄) for titania. These precursors are injected into a furnace cavity at high temperatures where they react to form silica and titania soot particles which are deposited at such that they are deposited and consolidated substantially simultaneously in a single step to form a silica-titania glass. In order to make a high OH glass, the key is to maintain a high partial pressure of water in the gas phase in the deposition chamber during deposition. Water vapor can be both generated and injected directly into the chamber. It could be generated from such reactions as by the combustion of methane, CH₄+O₂—→H₂O+CO (and/or CO₂ depending on how much oxygen is present). Water vapor can also be generated from reaction of hydrogen containing organic precursors and oxygen: for example, the organic moieties in PMCTS and TTP. In addition, water vapor can either be intentionally added or may enter the chamber as entrained air with some humidity level. Higher partial pressures of water will lead to higher OH levels in the glass. In one embodiment the partial pressure of water is greater than ≧3%. In another embodiment the partial pressure of water is ≧4%.

In another embodiment high OH silica-titania glass composition according to this disclosure are made by, for example without limitation, soot-to-glass processes such as the VAD (vertical axial deposition), OVD (outside vapor deposition), PSD or IVD (inside vapor deposition) in which the organic precursors are burned and deposited as porous soot in the first step. In a subsequent step the soot is consolidated at consolidation temperatures. During consolidation, the atmosphere in these process is normally helium by itself, which is a low OH atmosphere. In accordance with the present disclosure, the helium contains a partial pressure of water vapor exceeding about 3% or more. In some instances, the soot could be consolidated in pure water vapor or water vapor pressurized to 3 atmospheres in order to obtain OH levels of 600 ppm to 2500 ppm.

The above methods identify the methods by which silica-titania glasses with high OH levels can be made. Once the glass gas been made and fully consolidated, the next step is to anneal the glass at a rate of less than 100° C. /Hr to obtain the desired low T_{F}. Since low T_{F}'s are desirable, cooling rates of less than 3° C./Hr are preferred. The TiO₂ concentration and annealing rate can be adjusted in order to obtain the desired cross over temperature and expansivity behavior. As an example, more titania can be added to increase the cross over temperature and some can be taken away to decrease the cross over temperature.

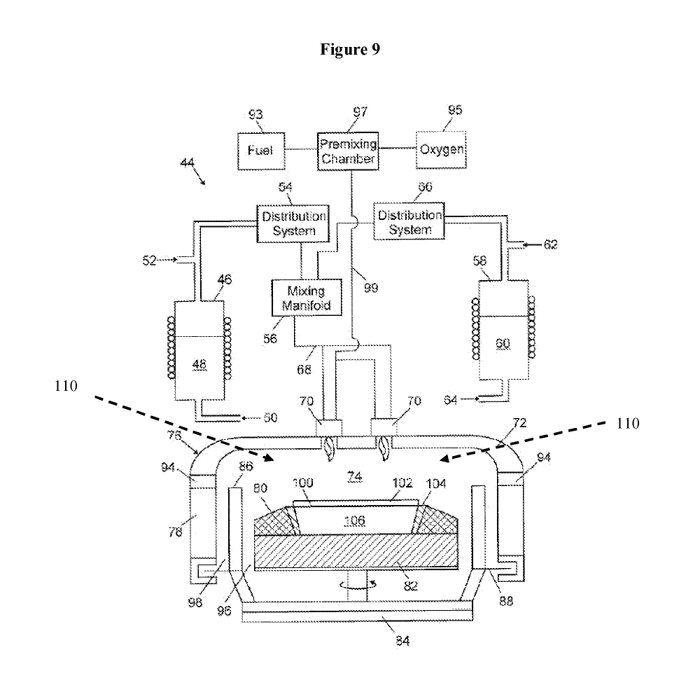

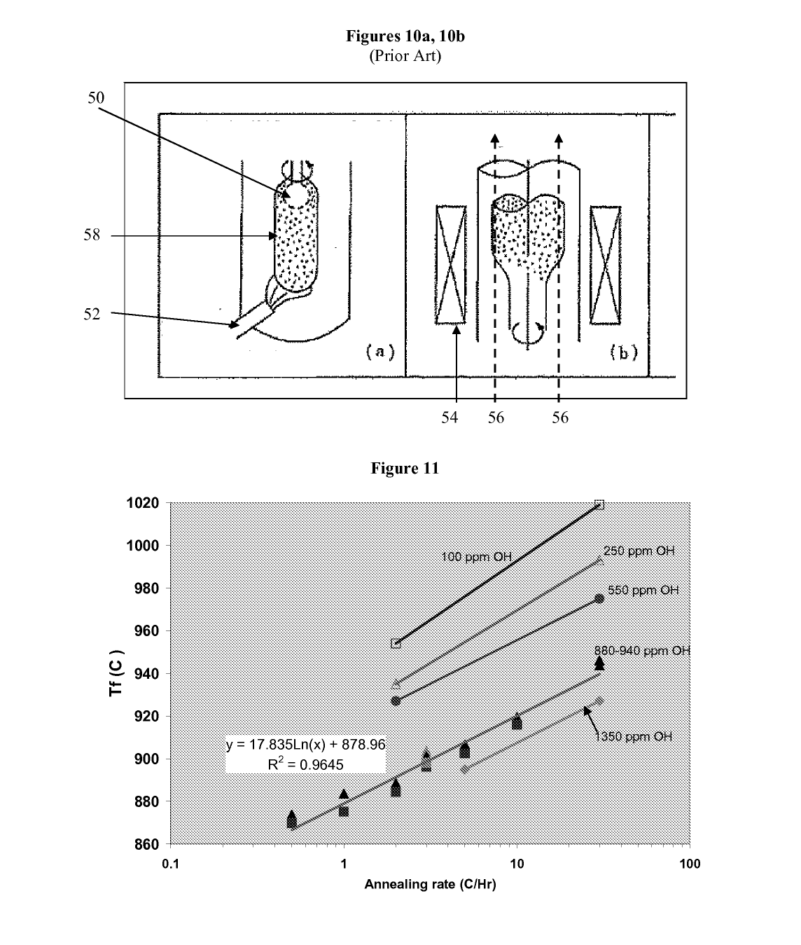

FIG. 9 illustrates an apparatus for making, depositing and consolidating a silica-titania soot in a vessel, wherein the dashed arrows 110 designate the introduction of a gaseous atmosphere containing water vapor according to the present disclosure. Using this apparatus the soot can either be (a) collected and consolidation in one step (the direct method) or (b) collected in a first step and consolidated in a second step. The apparatus illustrated in FIG. 10 are generally used to form boules having a diameter in the range of 0.2 meter to 2 meters, or larger and a thickness. As an example of the direct method, a source 46 of a silica precursor 48 and a source 58 of a titania precursor 60 are provided. The silica precursor 48 and titania precursor 60 are typically siloxanes, alkoxides, and tetrachlorides. One particularly commonly used silica precursor is OMCTS. One particularly commonly used titania precursor is Ti(OPri)₄. The sources 46, 58 may be vaporizers, evaporation tanks, or other equipment suitable for converting the precursors 48, 60 into vapor form. A carrier gas 50, such as nitrogen, is introduced at or near the base of source 46. The carrier gas 50 entrains the vapors of the silica precursor 48 and passes through a distribution system 54 to a mixing manifold 56. A by-pass stream of carrier gas is introduced at 52 to prevent saturation of the vaporous silica precursor stream. A stream of inert gas 62, e.g., nitrogen, can be brought into contact with the vaporous titania precursor to prevent saturation of the vapors. An inert carrier gas 64, e.g., nitrogen, entrains the titania precursor 60 vapors and carries the vapors through a distribution system 66 to the mixing manifold 56, where they are mixed with the silica precursor 48 vapors. Alternatively, the titania precursor 60 and the silica precursor 48 may be delivered to the mixing manifold 56 in liquid form. The mixture in the mixing manifold 56 passes through heated fume lines 68 to the burners 70 mounted on the furnace crown 72. In this illustration, two burners 70 are shown. However, more than two burners can be used to allow for better heat control and distribution of material across the deposition cavity 74. The furnace 76 may have rotation and oscillation capabilities and may include a stationary wall 78, which supports the crown 72. A containment vessel 80 is disposed within the stationary wall 78. The containment vessel 80 includes a base 82 which is supported for rotation and which also oscillates through its attachment to an oscillation table 84. The containment vessel 80 is surrounded by an air flow wall 86 which is mounted on the oscillation table 84. A motion accommodating seal 88 is formed between the stationary wall 78 and the containment vessel 80. The deposition cavity 74 is vented by a plurality of draft ports 94 formed at the top of the stationary wall 78. The draft ports 94 are connected to a suitable exhaust system (not shown) by ducting which creates a negative pressure in the deposition cavity 74 with respect to ambient pressure. Fuel 93 and oxygen 95 are premixed in the premixing chamber 97 and then transferred to the burners 70 through fume lines 99. The burners 70 ignite the fuel/oxygen mixture to produce a flame which heats the deposition cavity 74. The vaporous reactants injected into the burners 70 exit the burners 70 where they react and form titania-doped silica particles via flame hydrolysis or pyrolysis. The soot is directed downwardly and deposited on a planar surface 100, as shown at 102. The planar surface 100 may be provided by filling the liner 104 of the containment vessel 80 with cleaned cullet 106, although other means of providing a planar surface, such as a glass plate, may also be used. As the soot is deposited, the containment vessel 80, and hence the planar surface 100, is rotated and oscillated through the base 82 to improve index homogeneity of the silica. During soot deposition, the furnace 76 is drafted with ambient air, The temperature of the deposition cavity 74 is monitored and held at desired processing temperatures by adjusting the vertical position of the containment vessel 80. In the direct process the temperature is maintained at a consolidation temperature so that the silica-titania particles are formed and consolidate into glass substantially simultaneously. Such time is less generally less than three seconds and typically less than 2 seconds. In accordance with this disclosure, in order to obtain a high [OH] concentration in the glass, a partial pressure of water vapor, as described in the present disclosure. is maintained in the apparatus by injection of a gas containing a selected amount of water vapor at the top of the part of the furnace of FIG. 9 as illustrated by dashed arrows 110.

In an alternate embodiment, steam, high temperature steam from a pressurized vessel (not illustrated), can be injected into the top part of the furnace of FIG. 9 through feed lines that may also be represented by dashed arrows 110.

The soot particles 102 consolidate into a titania-doped silica glass inside the furnace 76. If desired, non-uniform reactions which may result in large variations in the CTE of the glass may be minimized by keeping the processing temperatures below that which is required for full consolidation of the soot particles 102. After deposition, the soot particles 102 can then be consolidated into glass, with maintenance of a partial pressure of water vapor in the furnace as described herein to that a high [OH] glass is formed.

As indicated above, silica-titania glass can also be made by soot-to-glass processes such as the VAD, OVD, PSD, or IVD in which the organic precursors are burned and deposited as porous soot in the first step. In a subsequent step the soot is consolidated at consolidation. As an example, the VAD process is used to make a consolidated silica-titania glass having a TiO₂ content in the range of 5-14 wt %. The VAD process has been described by S. Hayashi et al, “Development of Synthetic Silica Glass by the VAD Method”, Sumitomo, Vol. 42-3 (1990), pages 1-27 [translated by Phoenix Translations]. FIGS. 10(a) and 10(b) illustrate the steps of forming a porous silica-titania soot matrix by burning silica and titania precursors in a burner 52 and depositing the soot on a rotating bait 50 as illustrated in FIG. 10(a). The bait 50 is gradually raised during the process to form a cylindrical soot perform 58. Once the preform 58 is formed it is consolidated by heating with heaters 54 as shown in FIG. 10(b). In order to adjust the [OH] a gas containing a partial pressure of water vapor of at least 3% is flowed by and through the perform 58 during the consolidation process. As illustrated in FIG. 10(b) the preform has been inverted relative to FIG. 10(a) in order to allow gases within the preform to exit and thus to avoid the formation of inclusions (voids) within the glass during the consolidation process. The sintering is thus done from the lower end of the matrix to the upper end as illustrated in FIG. 10(b). High [OH] levels in accordance with this disclosure can be achieved by the injection of water vapor or steam as described above.

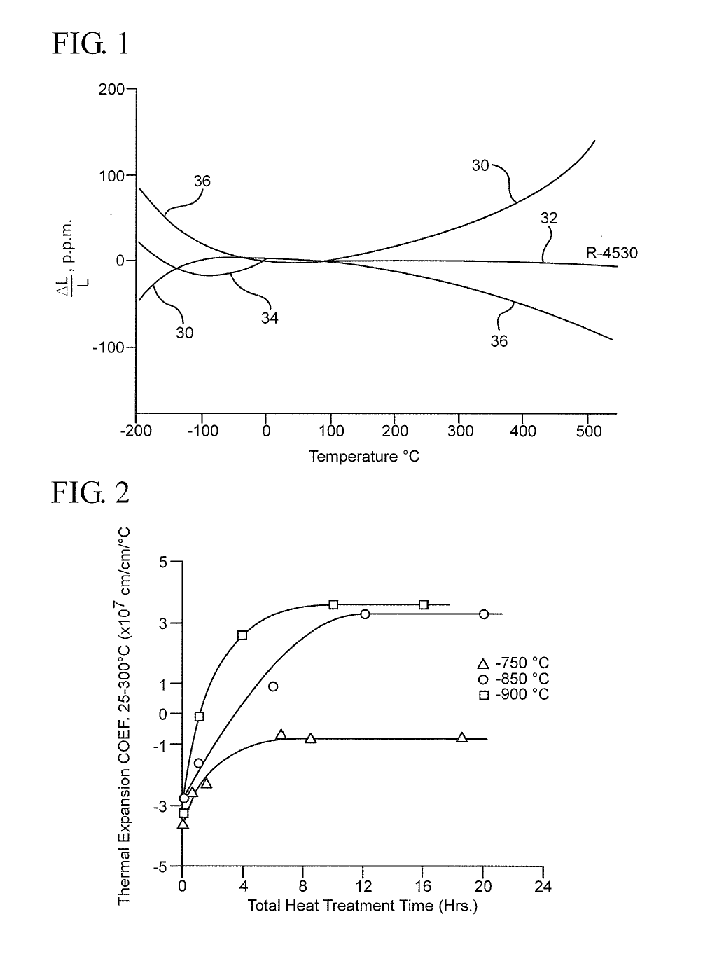

FIG. 1 shows the comparison of CTE for Cervit® (30), ULE (36) and the material of U.S. Pat. No. 3,390,855 (918 AS (numeral 3) and 918 AS after heat treating at 900° C. (numeral 34)). The expansivity of the glass 918 AS is flat over a wider temperature range than either of the other materials, but the disadvantage of this material is that it is not a single phase glass but a glass which contains titania crystallites. The titania crystallites have the potential of making polishing more difficult, especially to roughness levels of <1.5A rms. This for EUV applications is preferred that material be a glass is crystallite free or substantially crystallite free while have other desirable such as low thermal expansion and high polishability <1.5 nm rms).

FIG. 2 shows the effect of heat treatment of the material from U.S. Pat. No. 3,690,855. The heat treatments in these high titania containing glasses result in precipitation of titania crystallites. Again, it is preferred that the material be a single phase glass that is easier to polish than a multiphase material.

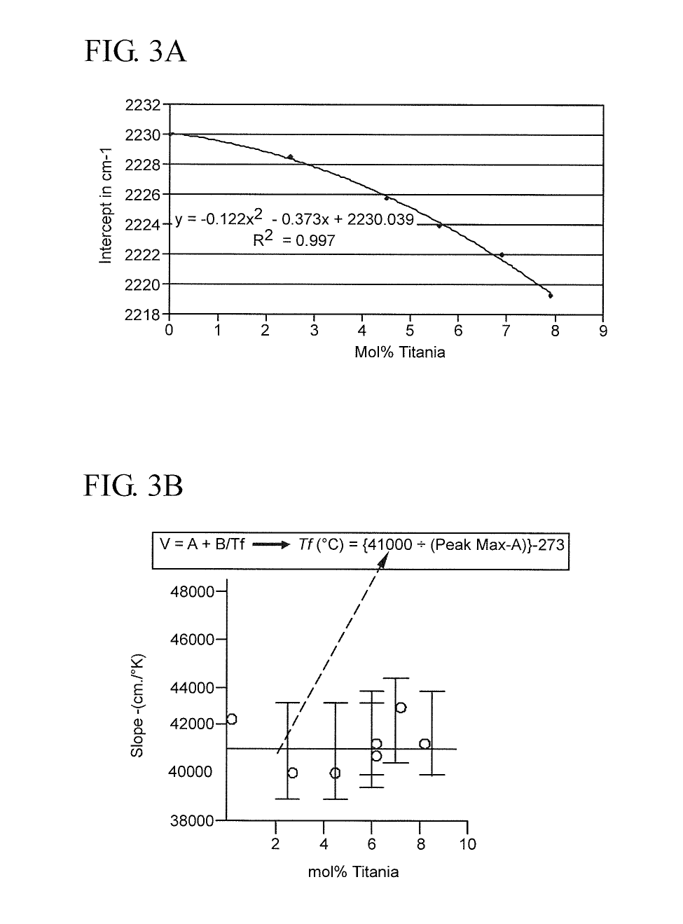

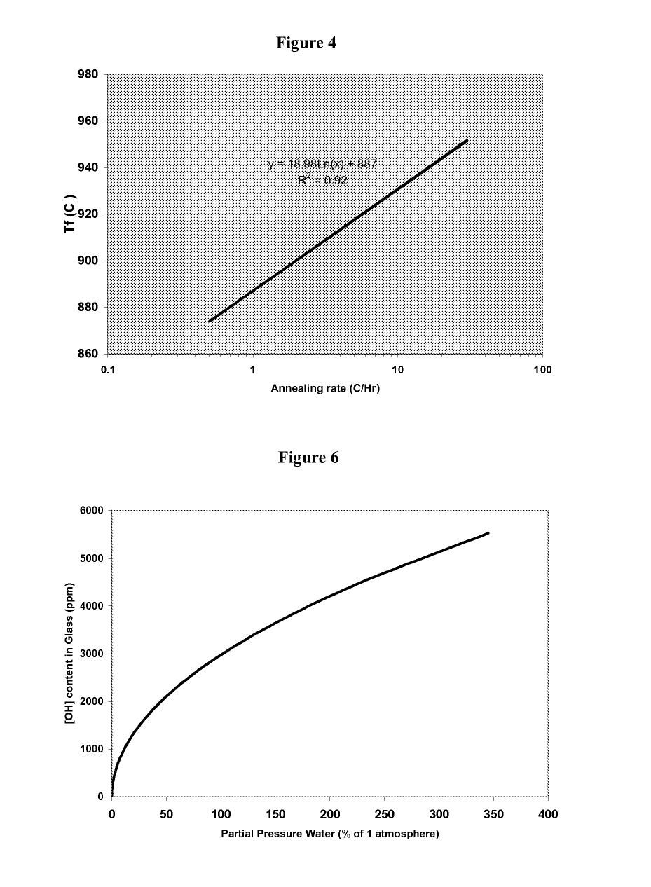

FIGS. 3A and 3B together illustrate the method used to calculate fictive temperature based on a paper by Shelby, “Density of TiO₂ doped vitreous silica,” Phys. Chem. of Glasses, Vol. 46 [5] (1995), pages 494-499. FIG. 3A illustrates the effect the of TiO₂ concentration on the intercept for the Agarwal, Davis, Tomozawa equation (Tomozawa equation, Eq. 1) shown in FIG. 3B. FIG. 3B illustrates the use of the Eq. 1:

V=A+B/Tf→Tf(° C.)={41000÷(Peak Max−A)}−273 (Eq. 1)

to calculate the intercept (A) in the Tomozawa equation for fictive temperature. V is the position of the band at 2260 cm⁻¹ (peak maximum), A is the intercept, and B is the slope (43809.21). (See A. Agarwal, K. M. Davis, M. Tomozawa, J. Non-Crystalline Solids, Vol. 185 (1995), pages 191-198. In FIG. 3B the symbol “602 ” (numeral 10) represents the data of the present disclosure.

FIG. 4 illustrates the fictive temperature changes as a function of the log of the annealing rate for a given titania doped silica glass with nominally 800 ppm OH and 7.4 wt % titania. The cooling or annealing rates are constant from about 1000° C. to about 800° C.

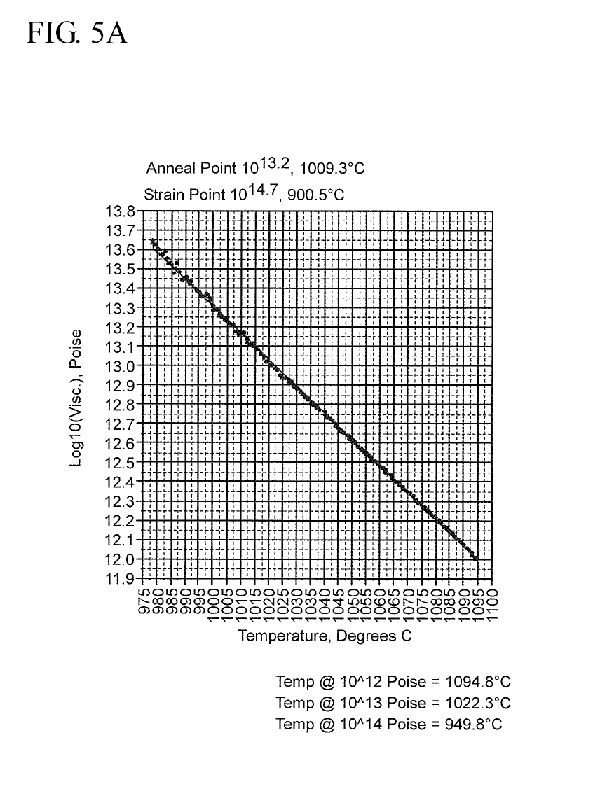

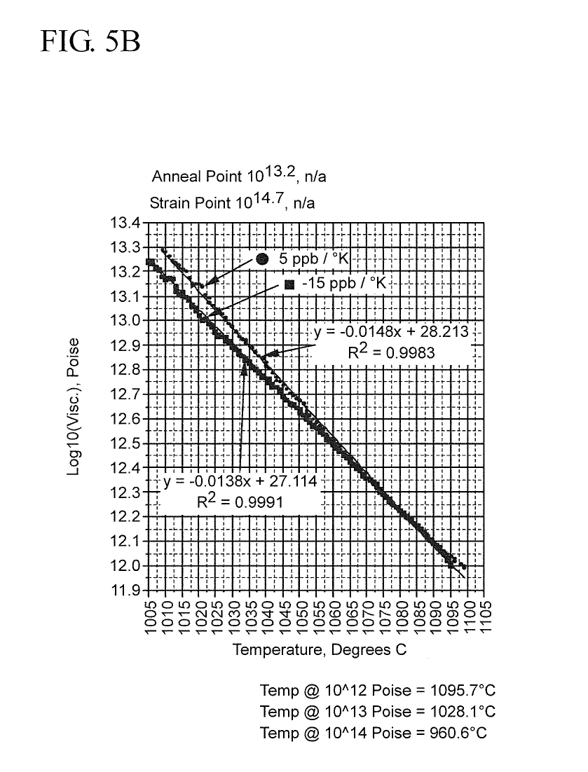

FIG. 5 illustrates the viscosity behavior of titania containing silica glass with nominally 800 ppm OH. Whose CTE is nominally −15 ppb/K and 5 ppb/K at 20 C.

FIG. 6 illustrates a semi-empirical relationship between partial pressure of water in the gas phase and the resultant [OH] in the glass. It demonstrates nominal partial pressures of water to target in order to achieve desired [OH] in the glass. For [OH] levels much greater than about 3000 ppm, the system would need to be pressurized.

EP 1 608 598 B1 contains a CTE versus Temperature graph of glasses having at most 600 ppm OH and different fictive temperatures. However, this patent does not identify high OH as a means of getting lower T_{F} values with improved expansivity properties. This patent thus described obtaining a glass with low T_{F} values only at lower [OH] levels; and does not identify high OH as a means of getting lower T_{F} values with improved expansivity properties, and in fact may be deemed to teach away from the present disclosure at Paragraphs [0025] and [0026].

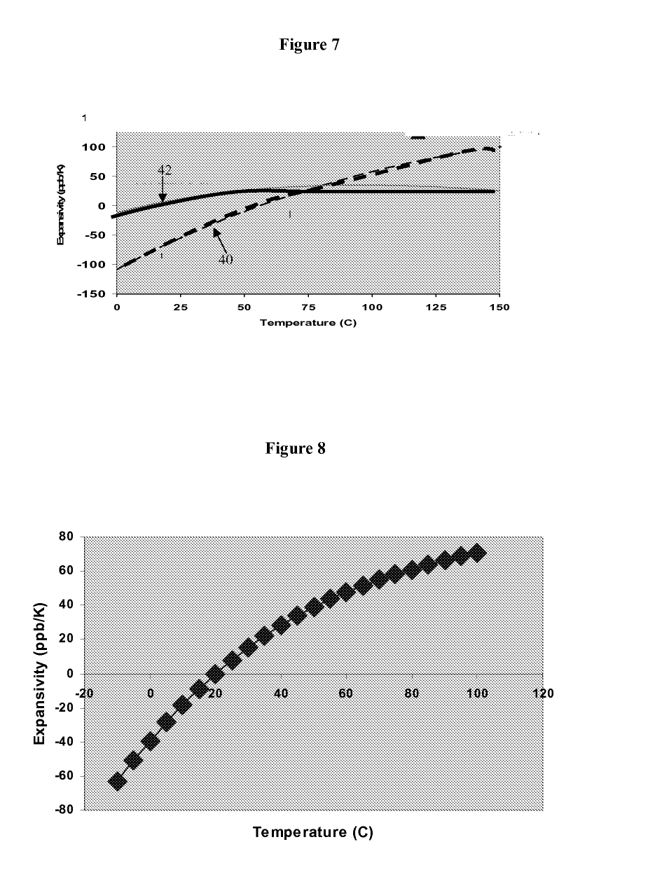

FIG. 7 is a graph illustrating the impact of annealing on thermal expansion of silica glass containing 7.4 wt % titania glass. Numeral 40 represents un-annealed glass that was simply cooled in the furnace after it was made. Numeral 42 represent glass that was heated to an annealing temperature of approximately 1010° and cooled at a rate of 3° C./Hr.

FIG. 8 illustrates expansivity as a function of temperature for a titania silica glass with nominally 800 ppm OH and 7.4 wt % TiO₂.

FIG. 11 a graph illustrating the fictive temperature (T_{f}) versus the annealing cooling rate for a series of silica-titania glasses with different OH content and nominally the same titania content of ˜7.4 wt % TiO2. For example, when the glass containing 880-940 ppm OH is cooled at a rate of 10° C./Hr the final fictive temperature (T_{f}) of the cooled glass will be approximately 920° c. When the same glass is cooled at a rate of 1° c/Hr the final fictive temperature will be approximately 880° C. The glasses used in FIG. 11 contained nominally 7.4 wt % titania. FIG. 12 can be used as a guide for determining the cooling rate that should be used for obtaining a specific fictive temperature for a glass having a given OH content which is determined before it is given a heat treatment as described herein.

Thus, the disclosure is directed to a silica-titania glass consisting essentially of 5-14 wt % titania and 86-95 wt % silica, said glass having a hydroxyl content [OH] in the range of 600-2500 ppm and a ΔCTE is less than 75 ppb/° K over the temperature range of 20° C. to 100° C., and an expansivity, δCTE/dT, of less than 1.6 ppb/° K². The silica-titania glass can have a hydroxyl content [OH] is in the range of 800-2000 ppm. In one embodiment the silica-titania glass contains 6.5-9 wt % titania and 91-93.5 wt % silica. In one embodiment the silica-titania glass ΔCTE is less than 65 ppb/° K over the temperature range of 20° C. to 100° C. The silica-titania glasses herein have an annealing point of 1010° C. or less and the glass have a fictive temperature T_{F} of less than 950° C. In one embodiment the fictive temperature T_{F} is less than 900° C. Further, the silica-titania glass has an expansivity, δCTE/dT, is less than 1.5 ppb/° K². In one embodiment the expansivity, δCTE/dT, is less than 1.4 ppb/° K².

The disclosure is also directed to a method of making a silica-titania glass having a hydroxyl content [OH] in the range of 600-2500 ppm, said method comprising providing an apparatus at least one burner for converting a silica precursor and titania precursor into a silica-titania soot; forming silica-titania soot in said at least one burner, and performing one selected from the group consisting of (a) depositing and consolidating, substantially simultaneously in a single step, said soot into glass in an atmosphere having a partial pressure of water vapor of ≧3%, and (b) depositing said soot to form a porous perform and consolidating said soot into glass in an atmosphere having a partial pressure of water vapor of ≧3%; and annealing said consolidated glass at an annealing point of 1010° C. or less to form a glass having a fictive temperature T_{F} of less than 950° C. In one aspect the partial pressure of water is at least 4%. In another aspect the silica-titania soot is deposited as a porous perform and the porous preform is consolidated in an atmosphere of pure water vapor to obtain OH levels in the range of 600 to 2500 ppm. In another aspect the silica-titania soot is deposited as a porous perform and the porous preform is consolidated in water vapor pressurized to 3 atmospheres (for example, by using a heated pressure chamber) to obtain OH levels in the range of 600 to 2500 ppm. The apparatus illustrated in FIG. 10 can be used to (i) make and deposit a silica-titania soot as a powder in a vessel or (ii) making a soot and depositing it with substantially simultaneously consolidation. In both cases the soot can be deposited in an atmosphere containing a partial pressure of ≧3% water vapor. The apparatus illustrated in FIGS. 10a/10b, and similar apparati, are generally used to make porous preforms that are subsequently consolidated into a glass. In this case the soot can be (i) deposited in an atmosphere containing any partial pressure of water vapor, but should be consolidated in water vapor >3%, or (ii) consolidated in water vapor pressurized to 3 atmospheres (for example, by using a heated pressure chamber).

The annealing, whose objective is to impart a uniform and controlled fictive temperature to the glass, was carried out by heating the glass from room temperature (“RT,” approximately 18-25° C.) to a selected temperature below the annealing point since the fictive temperature will be below the annealing point. The heating can be at any rate, for example, the heating rate is between 25° C./Hr and 150° C./Hr. In one embodiment the heating rate can be less than 25° C./Hr. The glass can held at the selected temperature for a time in the range of 1-500 hours depending on the thickness of the glass to insure that the glass reaches a nominally uniform fictive temperature throughout the glass. In one embodiment the glass was held at the selected temperature for a time in the range of 75-150 hours. The glass was then cooled at a rate of less than 100° C./Hr. In one embodiment the glass was cooled at a rate of ≦10°/Hr. In another embodiment the glass was cooled at a rate of ≦5° C./Hr. In a further embodiment the cooling rate was ≦3° C./hr. In one embodiment the glass was heated from RT to the annealing point at a rate of less than 50° C./Hr. In another embodiment the glass was heated from RT to the annealing point at a rate of less than 25° C./Hr. The glass was held at the annealing point for a time in the range of 1-200 hours, the exact time having a dependence on the thickness of the glass being annealed so that the glass reaches a substantially uniform temperature throughout.

In one example the glass is heated from RT to 600° C./Hr at a rate in the range of 50-100° C./Hr (for example 60-75° C./Hr), heated from 600° C. to 800° C. at a rate in the range of 25-50° C./Hr (for example 30-40° C.Hr), and from 800° C. to 1010° C./Hr at a rate in the range of 10-25° C./Hr (for example, 10-15° C./Hr). The glass was held at the annealing point for a time in the range of 75-150 hours. The glass was then cooled from the annealing point to RT at a rate of ≦5° C./Hr.

In another example the glass is heated from RT to an annealing point of 1010° C./Hr at a rate in the range of 5-10° C./Hr (for example 10° C./Hr), and held at the annealing point for a time in the range of 75-150 hours. The glass was then cooled to RT at a rate of ≦3° C./Hr.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

We claim:

1. A silica-titania glass consisting essentially of 5-14 wt % titania and 86-95 wt % silica, said glass having a hydroxyl content [OH] in the range of 600-2500 ppm and a ΔCTE is less than 75 ppb/° K over the temperature range of 20° C. to 100° C., and an expansivity, δCTE/dT, of less than 1.6 ppb/° K².

2. The silica-titania glass according to claim 1, wherein the hydroxyl content [OH] is in the range of 800-2000 ppm

3. The silica-titania glass according to claim 1, where the glass is 6.5-9 wt % titania and 91-93.5 wt % silica.

4. The silica-titania glass according to claim 1, wherein the ΔCTE is less than 65 ppb/° K over the temperature range of 20° C. to 100° C.

5. The silica-titania glass according to claim 1, wherein said glass has an annealing point of 1010° C. or less.

6. The silica-titania glass according to claim 1, wherein said glass has an annealing point of 1000° C. or less.

7. The silica-titania glass according to claim 1, wherein said glass has a fictive temperature T_{F} of less than 950° C. and an OH content of ≧800 ppm.

8. The silica-titania glass according to claim 1, wherein said glass has a fictive temperature T_{F} of less than 900° C. and an OH content of ≧800 ppm.

9. The silica-titania glass according to claim 1, wherein expansivity, δCTE/dT, is less than 1.5 ppb/° K² at 20° C.

10. The silica-titania glass according to claim 1, wherein expansivity, δCTE/dT, is less than 1.4 ppb/° K².

11. A method of making a silica-titania glass having a hydroxyl content [OH] in the range of 600-2500 ppm, said method comprising
providing an apparatus at least one burner for converting a silica precursor and titania precursor into a silica-titania soot;
forming silica-titania soot in said at least one burner, and performing one selected from the group consisting of:
(a) depositing and consolidating, substantially simultaneously in a single step, said soot into glass in an atmosphere having a partial pressure of water vapor of ≧3%, and
(b) depositing said soot to form a porous preform and consolidating said porous preform into glass in an atmosphere of pure water vapor at a pressure of ≧3 atmospheres;
annealing said consolidated glass at less than an annealing point of 1010° C. or less to form a glass having a fictive temperature T_{F} of less than 950° C., said glass being heated to the annealing point at a rate of 100° C./Hr or less, held at the annealing point for a time in the range of 1-8 hours, and cooled from the annealing point at a cooling rate of ≧10° C./H.

12. The method according to claim 11, wherein the glass is cooled from the annealing point at a cooling rate of ≧5° C./Hr.

13. The method according to claim 11, wherein the glass is cooled from the annealing point at a cooling rate of ≧3° C./Hr.

14. The method according to claim 11, wherein the partial pressure of water is at least 4%.

15. The method according to claim 10, wherein said silica-titania soot is deposited as a porous preform and the porous preform is consolidated in pure water vapor to obtain OH levels in the range of 600 to 2500 ppm.

16. The method according to claim 10, wherein said silica-titania soot is deposited as a porous perform and the porous preform is consolidated in water vapor pressurized to 3 atmospheres to obtain OH levels in the range of 600 to 2500 ppm.
